(19) United States
(12) Patent Application Publication
(10) Pub. No.: US 2004/0000824 A1
(43) Pub. Date: Jan. 1, 2004

(54) Electrical motor with spherically supported rotor

(76) Inventors: Karsten A. Laing, La Jolla, CA (US); Oliver P. Laing, Stuttgart (DE)

Correspondence Address: CHARMASSON & BUCHACA, 1545 HOTEL CIRCLE SOUTH, SUITE 150, SAN DIEGO, CA, 92108-3412, US

(21) Appl. No.: 10/265,086

(22) Filed: Oct. 3, 2002

Related U.S. Application Data
(63) Continuation-in-part of application No. 10/151,808, filed on May 20, 2002.

(51) Int. Cl. H02K 5/16; H02K 7/08

(52) U.S. Cl. 310/90

(57) ABSTRACT

To create an electric motor comprising a rotor, a stator and a bearing by which the rotor is spherically suspended, whereby the bearing comprises a bearing cap and a ball-shaped sliding partner which slides in the bearing cap, which motor allows a high degree of freedom in respect to the outer extensions while it has a play-free bearing, it is proposed that the rotor creates a magnetic field and that the bearing cap has a material-free area which is formed in such a way that a power vector of the total resulting force hits the material-free area when the rotor is asymmetric to the stator.

### PRIOR APPLICATION

This is a continuation-in-part of co-pending application Ser. No. 10/151,808, filed May 20, 2002

### FIELD OF THE INVENTION

The invention refers to a rotating electrical machine, comprising a rotor, a stator and a bearing by which the rotor is spherically supported, whereby the bearing comprises a bearing cap and a ball-shaped sliding partner positioned in the bearing cap. Such electrical motors are preferably used in centrifugal pumps. They have the advantage that a play-free support of the rotor can be achieved.

### BACKGROUND OF THE INVENTION

Such electric motors for instance are described in the German patent DE 33 02 349 A1 or in DE 1 538 717. Patent DE 29 02 492 A1 describes a rotor support with a bearing to automatically position a rotor by a fluid, whereby the bearing has a rotating bearing surface, which by rotating on a stationary sliding surface generates a pressure increase in the encased fluid whereby the generated fluid pressure is used for the axial positioning of the rotor within a limited distance.

### SUMMARY OF THE INVENTION

The object of this invention is to provide an electric motor as described above, which in addition to a high degree of freedom in respect to its outer dimensions has an essentially play-free bearing of the rotor.

According to the invention these objectives are achieved by using a rotor which generates a magnetic field and a bearing cap with a central material-free area. This area is sized such that the vector of the resulting total forces points to the material-free area when the rotor is unsymmetrical in relation to the stator.

When the rotor creates a magnetic field, especially through permanent magnetic poles over the circumference of the rotor, the rotor can be built with a short axial height, and consequently the electric motor according to the invention can be built with a short axial height, which makes it possible to build a circulator pump with short axial height by using such an electric motor.

Electric motors with permanent magnetic rotors have a high efficiency since the rotors do not create losses.

With a short axial height of the rotor, the axial component of the magnetic force will be small. In addition, the lines of force between the rotor and a yoke of the stator are divergent, so that in case of asymmetries of the rotor relative to the stator differences between the radial forces can occur. Especially, the radial forces for a magnetic pole closer to the stator will be larger than for a magnetic pole positioned on the opposite side of the first magnetic pole, which has more distance from the stator. The radial forces increase in such a case considerably with decreasing distance from the stator. Especially in connection with a reduced axial component of the magnetic force this means that the resulting total force, which is a combination of the hydraulic force and the total magnetic force, has a force vector which points to the bearing cap eccentrically with a radial component. This force causes a non-spherical abrasion especially in the bearing cap in which the sliding partner slides. This destroys the geometrical (spherical) configuration since wear takes place only on one side. In the bearing cap a ring-shaped channel can form, which can initiate a one-sided rolling movement. This sliding without full contact of the bearing surfaces can lead to imbalance, higher noise and further wear.

Aside from a mechanical asymmetry between rotor and stator, non-symmetric forces can result from asymmetric magnetization (anisotropic magnetization) resulting in a non-axial total force.

According to the invention a material-free central area is provided so that even in case of asymmetry between rotor and stator (for instance in case of mechanical asymmetry and/or magnetic anisotropy) there will be no one-sided wear on the bearing (which could result for example in different circumferential speeds). The invention makes it possible to use a permanent magnetic rotor, for example to minimize the axial height of an electric motor, whereby problems caused by non-spherical wear are avoided.

In principle it is possible to attach the ball-shaped sliding partner to the rotor and to connect the bearing cap with the stationary stator. However, it is advantageous to connect the bearing cap with the rotor and the sliding part with the stator. This simplifies the lubrication of the bearing for instance by using the fluid conveyed by a circulation pump in which the electric motor is used.

Especially it is intended that the rotor has one or more permanent magnets to produce the magnetic field. For example four or six magnetic poles with alternating polarization can be distributed over the circumference of the rotor.

It is intended that the surface of the rotor facing the stator and especially the yoke has a hemispherical shape in order to form a spherical motor.

Between the stator and the rotor there is an air-gap delimited by spherical surface areas.

It is especially advantageous when the material-free central area is arranged around a lubricating hole and/or forms a lubrication hole. In this case the lubrication fluid can get through the central material-free area to the sliding surfaces of the ball shaped sliding partner and the bearing cap. One of the sliding surfaces will have a concave shape.

In addition it will be advantageous when the material-free central area is arranged symmetrical to the axis of the rotor so that the starting point will be the ideal situation when stator and rotor are in concentric. In this case asymmetries in any radial direction are included.

It is advantageous when the surface of the bearing cap consists of a hollow cylindrical shape followed in axial direction by a hemispherical sector. In these sections the sliding partner is inserted whereby it slides against the concave walls of the spherical sector.

Preferably, the material-free area is situated within the spherical part of the bearing cap since it contains the concave sliding surface.

It is especially advantageous when the diameter of the material-free area is sized depending on production tolerances. If it is guaranteed that rotor and stator are exactly symmetric and the magnetic field is isotropic, the size of the material-free area can be minimized. Since this cannot be guaranteed in mass production, the material-free area must have a certain dimension. In this case the maximum (permissible) asymmetries covered by the production tolerances are used for the sizing of the material-free area, adding the mechanical and the magnetic asymmety. For this maximal deviation from the (spherical) symmetry the direction of the resulting total force vector is determined whereby this vector must point to the material-free area and not to material areas of the bearing cap. If this is achieved, no non-spherical wear of the bearing will take place.

In practice it has proven sufficient when the diameter of the material-free area is equal or larger than 0.5 times the diameter of the sliding partner. With larger production tolerances a diameter of the material-free area of 0.6 times the diameter of the gliding partner is preferable.

The diameter of the material-free area is always smaller than the diameter of the sliding partner so that there is still a concave support area for the sliding partner in the bearing cap.

The electric motor according to the invention can be applied in a circulating pump which will be a centrifugal pump.

### BRIEF DESCRIPTION OF THE DRAWINGS

FIG. 1 shows a perspective cross-sectional view of an electrically driven pump assembly.

FIG. 2 shows a schematic cross-section along line 2-2 of FIG. 1 showing the magnetic field of a magnetic field generating rotor according to the invention.

FIG. 3 shows in schematic presentation the magnetic field generated by a stator according to the prior art.

FIG. 4 shows a part of the rotor and the stator and the resulting forces.

FIG. 5 shows a cross-sectional view of a bearing according to the invention.

### DESCRIPTION OF THE PREFERRED EMBODIMENTS OF THE INVENTION

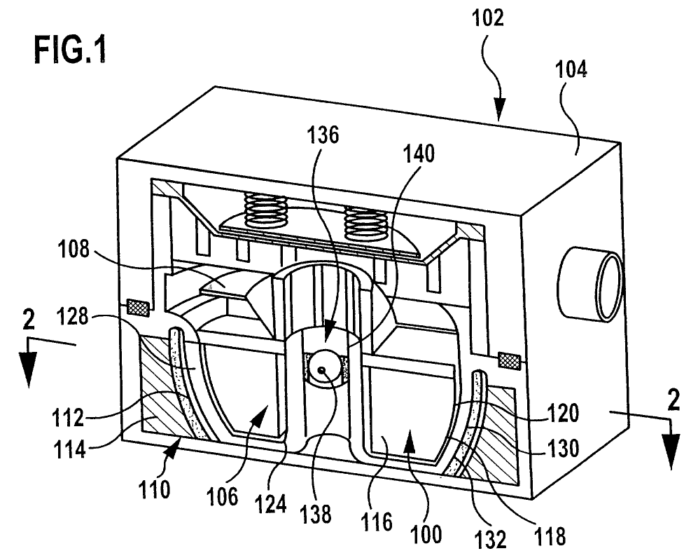

FIG. 1 shows a motor assembly 100 as part of a circulating pump 102, forming a pump-motor-unit. The circulating pump 102 includes a housing 104 in which the electric motor 100 is arranged. The circulating pump forms a centrifugal pump.

The electric motor 100 has a rotor 106, which is connected with the pump impeller 108 to form a rotor-impeller unit. Furthermore the electric motor 100 has a stator 110 with one or more windings 112 and a soft magnetic yoke 114. The stator 110 is fixed in the housing 104. The rotor 106 creates a magnetic field. To this effect, it contains one or more magnetic elements 116 which are permanent magnetic and are magnetized in radial direction. The magnetic elements 116 are formed by permanent magnets of high coercitive force, whereby the magnetic poles of the magnetic elements are distributed over the circumference of the rotor 106 with alternating polarization.

One surface 118 of the rotor 106 facing the stator 110 is part of a spherical surface. The magnetic elements 116 follow the shape of this surface. To protect the magnetic elements 116, the rotor 106 has a casing 120 consisting of plastic or stainless steel, which forms its surface 118.

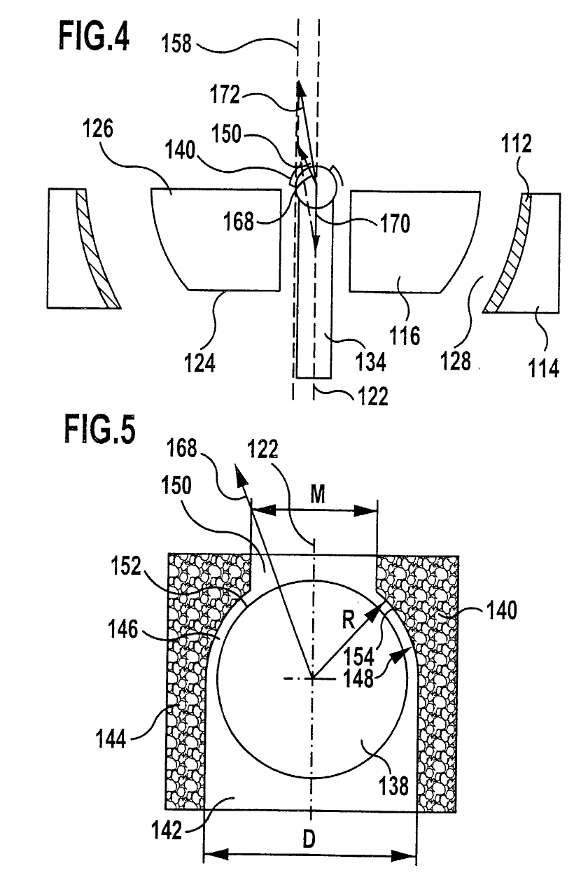

The spherical surface 118 corresponds with the spherical segment of an imaginary ball, which was cut perpendicular to an axis 122 (FIG. 4) running through the center of the ball. This has the effect that area 124 of the rotor 106 facing the housing 104 has a surface which is essentially flat. The same applies to an area 126 of the rotor 106 which faces the pump impeller 108.

The winding respectively windings 112 of the stator 110 are arranged around the rotor 106.

Between the rotor 106 and the stator 110 and especially its yoke 114 there is an air gap 128 of the magnetic loop. Separate segments of spherical surfaces, being on one side the surface 118 and on the other side the spherical surface 130 of a wall 132 enclosing the winding or windings 112, form a part of the air gap 128. The wall 132 acts as separation wall between the dry parts and the wet parts of the circulation pump 102.

The rotor 106 is supported by a spherical bearing thus forming a centrifugal pump. Such a bearing 136 comprises a ball-shaped sliding partner 138 mounted at the tip of a post 134 (FIG. 4). The post 134 is mounted fixed in the housing 104. The center of the sliding partner 138 lies on the axis of the rotor 122. In addition, the center of the sliding partner 138 also coincides essentially with the center of the imaginary ball forming the surface 118.

The bearing 136 furthermore comprises a bearing cap 140 (FIG. 5), which for example consists of carbon. The sliding partner 138, consisting of a hard material, preferably ceramic, can slide relative to the bearing cap 140. The bearing cap 140 forms a unit with the rotor 106. This leads to a substantially play-free support of the rotor 106 in the housing 104.

As shown in FIG. 5, the bearing cap 140 consists of a hollow cylindrical part 142 with a diameter D which essentially corresponds with the diameter d of the ball-shaped sliding partner 138. Between the ball 138 and the wall of the bearing cap 144 there can be an air gap 146 whose extension perpendicular to the axis 122 is considerably smaller than the diameter d of the sliding partner 138.

The hollow cylindrical segment 142 is followed in axial direction (in direction of the axis 122) by a spherical section 148, whereby the center of the imaginary ball forming this spherical section coincides with the center of the sliding partner 138, which is formed by a sliding ball for the bearing 136. A radius R of this imaginary ball, forming the spherical section 148 coincides with the radius d/2 of the ball forming the sliding partner 138.

A central, material-free area 150 is situated in the bearing cap 140 around the axis 122 of the rotor 106. This is positioned within the spherical section 148 and is connected by the spherical section 148 to the hollow cylindrical section 142. This central, material-free area 150 is symmetrical to the axis 122 and has a diameter M.

The central material-free area 150 forms a lubrication hole through which lubricant such as fluid conveyed can be supplied to a sliding surface 152 of the sliding partner 138 and a sliding surface 154 of the bearing cap 140, especially within the spherical section 148.

The sliding partner 138, mounted at the tip of the post 134 is inserted in the axial cylindrical channel 142 of the bearing cap 140 and can slide on the spherical section 148 relative to the bearing cap 140. Via the spherical section 148 it is possible to transfer axial and radial forces from the rotor 106 to the ball 138. Correspondingly, the sliding partner 138 exerts a counterforce onto the rotor 106 and thereby onto the bearing cap 140.

The rotor 106 forms a magnetic field by magnetic elements 116, which means that the magnetic field originates from the rotor 106. FIG. 2 shows the magnetic lines of force in a schematic presentation. Lines of force 156 run within the air-gap between the rotor 106 and the soft magnetic yoke 114 of the stator. These lines of force do not run parallel to each other but experience a relatively strong curvature. This causes large radial force differences when the rotor 106 is moved eccentrically in relation to the stator 110, especially when the axis 158 of the stator 110 and the axis 122 of the rotor 106 do no longer coincide with each other. A magnetic pole of the magnet 116 which moves closer to the yoke 114 due to the eccentricity experiences a larger radial force than the magnetic pole diametrical to the first pole which has a larger distance from the yoke 114. A movement out of the concentric position thus causes an increase of the radial force in the magnetic pole closer to the yoke while the radial force decreases in the pole on the opposite side. This causes instability in the bearing.

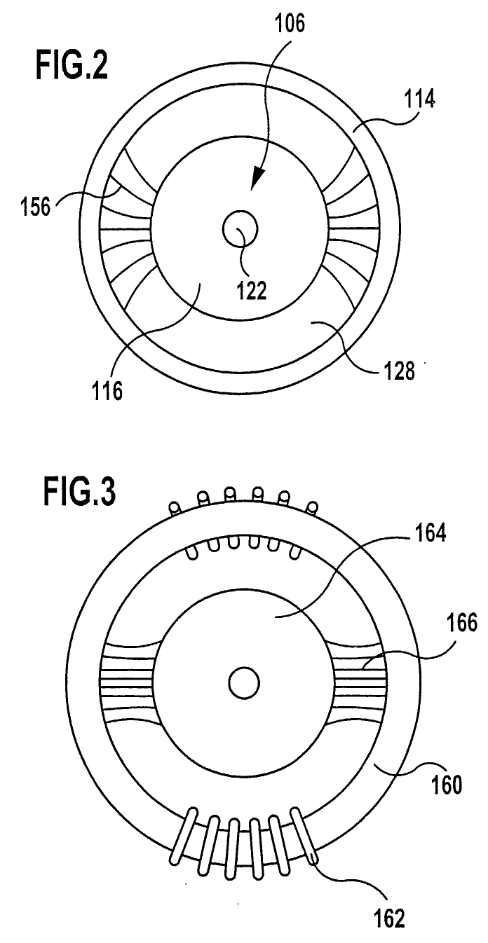

To compare the system according to the invention with the prior art, FIG. 3 shows a similar view of the device in FIG. 2, whereby here the stator 160 with a winding 162 creates the magnetic field. Here the lines of force 166 between the rotor 164 and the stator 160 run almost parallel to each other. A movement out of the center position here does not result in significant differences in the radial forces, so that an eccentricity does not influence the function of the bearing.

Aside from or instead of asymmetries between the rotor 106 and the stator 110 due to eccentric positions there can be asymmetries in the magnetizing or asymmetries in the form of the air gap which lead to resulting magnetic forces with a radial component.

The central material-free area 150 according to the invention substantially eliminates the problems and especially the wear problems caused by asymmetry, for instance eccentricity between the rotor 106 and the stator 110, as described in connection with FIG. 2.

The rotor 106 experiences a force composed of the hydraulic force and the resulting magnetic force. It exerts a resulting force on the ball 138 whose resulting counterforce 168 (FIG. 4) is exerted from the ball 138 on the bearing cap 140. The resulting counter force 168 is the resultant of the hydraulic counter force 170 and the resulting magnetic counter force 172. If the rotor 106 is positioned in the center, i.e. when its axis 122 coincides with the axis 158 of the stator 110, the radial component of the resulting magnetic counter force 172 is zero if the magnetization is isotropic and the resulting counter force 168 acts in the direction of the axis 122.

However, if the rotor 106 is asymmetric to the stator 110, for example if there is a distance between the parallel axes 122 and 158, as shown in FIG. 4, then the diverging lines of force in a rotor 106 which produces the magnetic field result in a difference of the radial force. Since in addition the axial component of the resulting magnetic counter force 172 is relatively small when the rotor 106 with its magnetic elements 116 has a small height in the direction of its axis 122, the resulting counterforce 168 as shown in FIG. 4 does not point in the same direction as the hydraulic counter force 170, namely in direction of the axis 122, but at an angle.

This would mean that the ball 138 would exert pressure on the bearing cap 140 eccentrically when there is an asymmetry between rotor 106 and stator 110, with corresponding wear of the bearing cap 140. In this case the wear of the bearing cap 140 would not be spherically symmetric, but instead a ring channel would form within the bearing cap. If this is the case, the bearing cap 140 can initiate a one-sided rolling movement while rotating around the sliding element 138 instead of sliding on the whole spherical surface of the ball 138. This leads to imbalance, increased and accelerating non-spherical wear.

According to the invention the central material-free area 150 is arranged and formed in such a way that the resulting counter force 168 points to this material free area, which means it points to a hole. This area is so large that the force vector 168 points to fluid and not material of the bearing cap 140. This prevents non-spherical wear of the bearing cap 140 even if the resulting force vector 168 is at an angle, so that over a long time the play-free support of the rotor 106 in the housing 104 is guaranteed.

The diameter M of the central material-free area 150 is chosen especially in respect to the production tolerances including anisotropy in the magnetizing of the rotor: The smaller the production tolerances the smaller this diameter can be chosen. The production tolerances refer to the dimension and form of the sliding partner 138, the spherical section 148, the precision of the axis in relation to the position of the sliding partner 138 on the post 134, the precision of the axis of the stator 1 10, the isotropy of the magnetization etc., whereby these values bear some relation to each other.

If a maximum (acceptable) deviation of the symmetry between rotor 106 and stator 110 due to production tolerances is expected, the diameter M of the central material-free area 150 should be chosen such that the force vector of the resulting counter force 168 points to this material-free section.

In practice it turned out that it is advantageous when M has a size of 0.5 times the diameter d of the ball-shaped sliding partner 138. It is especially advantageous when M is at least 0.6 times the diameter d of the ball 138. To leave room for to the spherical section 148, M must be smaller than the diameter d of the ball 138.

Through the solution of this invention, electric motors 100 and circulator pumps 102 can be realized which have a small axial height in direction of the axis 158; for instance the total height can be smaller than 4 cm. This can be achieved when the rotor 106 produces the magnetic field by permanent magnetic poles. This results in a small axial component of the magnetic force and in an unfavorable radial component of the magnetic force for the bearing when an asymmetrical situation exists.

By providing a central material-free area 150 these problems are solved in their effect on the bearing 136. This material-free area 150 which is chosen such that the total resulting counter-force 168 does not point to a material section, a non-spherical wear of the bearing cap 140 will be prevented, which otherwise could lead to different circumferential speeds of the ball and thereby for instance to higher mechanical vibration and to a shorter lifetime of the electric motor 110.

I claim:

1. Electric motor comprising a rotor (106), a stator (110) and a bearing (136) on which the rotor (106) is spherically supported, whereby the bearing (136) comprises a bearing cap (140) and a ball-shaped sliding partner (138) positioned in the bearing cap, characterized in that the rotor (106) induces a magnetic field and that the bearing cap (140) has a central material-free area (150) which is formed in such a way that the vector of the resulting total force points to the material-free area (150) when the rotor (106) is asymmetric in respect to the stator (110).

2. Electric motor according to claim 1, characterized in that the bearing cap (140) forms a unit with the rotor (106)

3. Electric motor according to claim 1 or 2, characterized in that the sliding partner (138) forms a unit with the stator (110).

4. Electric motor according to one or more of the forgoing claims, characterized in that the rotor (106) comprises one ore more permanent magnets (116).

5. Electric motor according to one or more of the forgoing claims, characterized in that the rotor (106) contains a spherical surface area (118) facing the Stator.

6. Electric motor according to one or more of the forgoing claims, characterized in that an air gap (128) is formed between the rotor (106) and the stator (110) by the spherical surface areas (118, 130) having a distance from each other.

7. Electric motor according to one or more of the forgoing claims, characterized in that the central material-free area (15) is arranged around a lubrication hole and/or forms a lubrication hole.

8. Electric motor according to one or more of the forgoing claims, characterized in that the material-free area (150) is situated around an axis (122) of the rotor (106).

9. Electric motor according to one or more of the forgoing claims, characterized in that the material-free area (150) is arranged axially symmetrical around the axis (122)

10. Electric motor according to one or more of the forgoing claims, characterized in that the bearing cap (140) has a hollow cylindrical section (142) and a spherical section (148) which follows the hollow cylindrical section (142) in axial direction.

11. Electric motor according to one or more of the forgoing claims, characterized in that the material-free section (150) is positioned in the spherical section (148).

12. Electric motor according to one or more of the forgoing claims, characterized in that the diameter (M) of the material-free section (150) will be chosen as a function of the production tolerances.

13. Electric motor according to one or more of the forgoing claims, characterized in that a diameter (M) of the material-free section (150) is equal to or larger than 0.5 times the diameter (d) of the sliding partner (138).

14. Electric motor according to one or more of the forgoing claims, characterized in that a diameter (M) of the material-free section (150) is equal to or larger than 0.6 times the diameter (d) of the sliding partner (138).

15. Electric motor according to one or more of the forgoing claims, characterized in that a diameter (M) of the material-free section (150) is smaller the diameter (d) of the sliding partner (138).

16. Circulator pump which comprises an electric motor (100) according to one or more of the forgoing claims.
